(19) United States
(12) Patent Application Publication
(10) Pub. No.: US 2023/0069113 A1
(43) Pub. Date: Mar. 2, 2023

(54) Text Summarization Method and Text Summarization System

(71) Applicant: Hitachi, Ltd., Tokyo (JP)

(72) Inventors: Gaku TSUCHIDA, Tokyo (JP); Atsuki YAMAGUCHI, Tokyo (JP); Hiroaki OZAKI, Tokyo (JP); Kenichi YOKOTE, Tokyo (JP)

(21) Appl. No.: 17/875,512

(22) Filed: Jul. 28, 2022

(30) Foreign Application Priority Data
Aug. 30, 2021 (JP) 2021-140376

(51) Int. Cl. G06F 16/34; G06F 40/58; G06F 40/279

(52) U.S. Cl. CPC G06F 16/345; G06F 40/58; G06F 40/279

(57) ABSTRACT

A text can be automatically summarized with high accuracy. A text summarization method is executed by a computer, and includes: a blocking step of receiving an input of a text and generating a blocked text in which the text is segmented into blocks in topic units; a summarizing step of summarizing content of the text for each of the blocks in the blocked text and outputting a summarized text; and a structuring step of structuring content of the summarized text and outputting the structured content.

### BACKGROUND OF THE INVENTION

### 1. Field of the Invention

The present invention relates to a text summarization method and a text summarization system.

### 2. Description of the Related Art

In a response from a conference or a call center, information exchange, instruction, or decision making is performed through an utterance of a person. A document (utterance text) in which an utterance content is transcribed contains a history of the utterance and information on an utterer. Automatically summarizing (performing automatic summarization on) such an utterance text and presenting the summarized utterance text to a person is an important technique of supporting retracement of the conference and the decision making.

The automatic summarization of the utterance text must be easy to read and accurate for a person (user) who is to confirm a result of the automatic summarization. For example, by presenting contents of appropriate main points, opinions, reasons, and the like from the utterance text to the user in a structured form, the accuracy of the automatic summarization can be improved. As a technique of presenting high-accuracy automatic summarization, a technique of dividing an utterance text into appropriate lengths (blocking), a technique of extracting an important part from an utterance text to perform the summarization (extractive summarization), a technique of simply replaying an utterance text (abstractive summarization), a technique of converting an utterance text into a format that is easily understood by a person and displaying the converted utterance text (structuring), and the like are used, and all the techniques use a technique of natural language processing.

In the blocking, one or more subsets of the utterance text are obtained from the utterance text by dividing or extracting the utterance text. For example, in the blocking, the accuracy of the automatic summarization can be improved by cutting the utterance text to a length that can be processed by a machine and summarizing each cut text. In addition, for example, it is possible to automatically summarize a specific topic and present the specific topic to the user by performing the blocking of dividing and extracting only an utterance portion related to an important topic. JP-A-2005-122743 discloses a method of determining a hybrid text summary including the steps of: determining discourse elements for a text; determining a structural representation of discourse for the text; determining relevance scores for the discourse elements based on at least one non-structural measure of relevance; percolating the relevance scores based on the structural representation of the discourse; and determining a hybrid text summary based on the discourse elements with the relevance scores compared to a threshold relevance score.

In the abstractive summarization, an original utterance text is converted into a text that expresses the original utterance text in a short manner by briefly summarizing the main points of the utterance text. For example, a method of causing a computer to recognize a summarization range of a document having a formal hierarchical structure and create a summarization document of the summarization range. In addition, a neural network may be used as a technique of performing the abstractive summarization. For example, in the abstractive summarization, a text serving as an automatic summarization source can be converted into a summary sentence having an appropriate length by a neural model such as an Encoder-Decoder model. In addition, in recent years, it is considered to use bidirectional encoder representations from transformers (BERT) or bidirectional and auto-regressive transformers (BART), which are pre-learned language models. The BERT and BART accumulate knowledge from a large amount of texts collected from World Wide Web, and use the accumulated knowledge to generate automatic summarization, thereby generating an extremely fluency and high-accuracy summary.

In the structuring, a summary that is easy for the user to understand is presented to the user by estimating an appropriate structure based on the utterance text and displaying the estimated structure. For example, it is considered to extract a portion of describing an opinion from the utterance text and to perform the automatic summarization for presenting the extracted portion to the user in a bullet list format.

The utterance text contains noise generated by voice recognition, and it is difficult to use low-accuracy abstractive summarization in the related art for the utterance text. In addition, for example, the utterance text contains a large number of phrases unrelated to an essence of a discussion, for example, a filler such as “uh” or “ah” unique to a colloquialism, a greeting, or a confirmation on connection to an online conference. Such unnecessary phrases can be theoretically removed by the abstractive summarization, but the unnecessary phrases still cannot be removed by performance of the abstractive summarization in the related art, and even if the automatically summarized result is presented to the user, readability is low for the user.

In this way, in a summarization system for a minute in the related art, it is technically difficult to perform the abstractive summarization, therefore a method of structuring an utterance text using extractive summarization, a sentence classification, and the like, and then performing abstractive summarization, that is, a method of “structuring and then summarizing” is adopted. For example, a method of structuring by classifying a sentence extracted by extractive summarization into a specific category, and finally realizing automatic summarization by converting a style of the extracted sentence is known. However, the method of “structuring and then summarizing (in this case, converting a style)” depends on the result of the extractive summarization and the result of structuring when the summary of the text is classified into the specific category, therefore continuity and context are not considered in the summarization results, which may cause unnatural in terms of language and semantic. In the technique disclosed in JP-A-2005-122743, there is room for improvement in automatic summarization of a text.

### SUMMARY OF THE INVENTION

A text summarization method according to a first aspect of the invention is a text summarization method executed by a computer. The text summarization method includes: a blocking step of receiving an input of a text and generating a blocked text in which the text is segmented to blocks in topic units; a summarizing step of summarizing content of the text for each of the blocks in the blocked text and outputting a summarized text; and a structuring step of structuring content of the summarized text and outputting the structured content.

A text summarization system according to a second aspect of the invention includes: a blocking unit configured to receive an input of a text and generate a blocked text in which the text is segmented to blocks in topic units; a summarizing unit configured to summarize content of the text for each of the blocks in the blocked text and output a summarized text; and a structuring unit configured to structure content of the summarized text and output the structured content.

According to the invention, a text can be automatically summarized with high accuracy.

### BRIEF DESCRIPTION OF THE DRAWINGS

FIG. 1 is a system configuration diagram of a text summarization system according to a first embodiment.

FIG. 2 is a diagram showing an input text and a processing example of a blocking unit.

FIG. 3 is a diagram showing an input screen of blocking parameters for determining an operation of the blocking unit.

FIG. 4 is a diagram showing a processing example of a summarizing unit.

FIG. 5 is a diagram showing a processing example of a structuring unit.

FIG. 6 is a diagram showing an input screen of structuring parameters for determining an operation of the structuring unit.

FIG. 7 is a system configuration diagram of a text summarization system according to a second embodiment.

FIG. 8 is a system configuration diagram of a text summarization system according to a third embodiment.

FIG. 9 is a diagram showing an example of identifying utterers.

FIG. 10 is a diagram showing an example of performing blocking and structuring after the utterers are identified.

FIG. 11 is a system configuration diagram of a text summarization system according to a fourth embodiment.

FIG. 12 is a hardware configuration diagram of a computer that implements the text summarization system.

### DESCRIPTION OF THE PREFERRED EMBODIMENTS

Embodiments of the invention will be described with reference to drawings. Hereinafter, each of the embodiments and each of modifications can be partly or wholly combined without departing from the spirit of the invention.

### First Embodiment

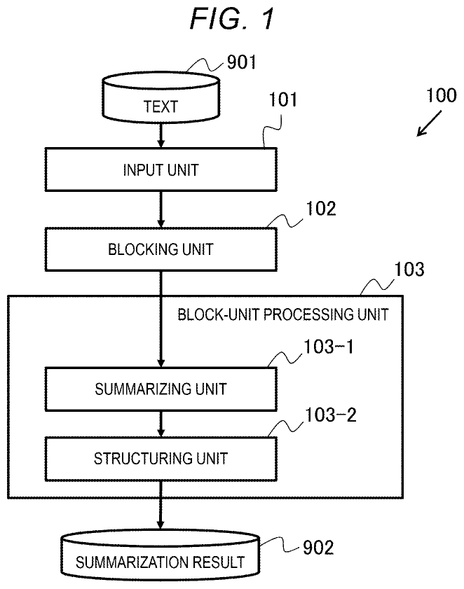

Hereinafter, a text summarization system according to a first embodiment will be described with reference to FIGS. 1 to 6. In the following description, the text summarization system receives a text as an input and generates blocks by segmenting the text in topic units. Then, the text summarization system summarizes content for each block, structures a summary, and presents the automatically summarized result to a user.

### System Configuration

FIG. 1 is a system configuration diagram of a text summarization system 100. The text summarization system 100 according to the first embodiment includes an input unit 101, a blocking unit 102, and a block-unit processing unit 103. The block-unit processing unit 103 includes a summarizing unit 103-1 and a structuring unit 103-2. In the present embodiment, for example, an utterance text can be input, and an automatic summarized result can be presented to the user. The automatic summarization presented to the user can be applied to various applications such as automatic summarization of a minute, automatic summarization of an utterance response of a call center, and an automatic creation of a report.

The input unit 101 receives a text including character strings as an input, and outputs the text to the blocking unit 102. The input unit 101 receives various types of input formats such as a minute, an utterance response, and a chat history. In addition, the input formats to the input unit 101 may be a structured data format such as a database (DB), or may be a non-structured data format such as a text, a file format of document processing software, a file format of spreadsheet software, a Web page, and a portable document format (PDF). In addition, an image or a table may be inserted into a file to be input to the input unit 101. Further, in the first embodiment, a description is made on an assumption that the text is in English, but there is no problem even if the text is in another language such as Japanese or Chinese.

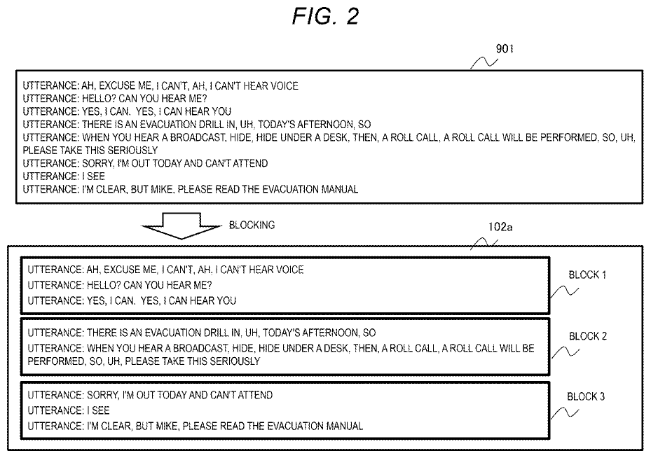

The input unit 101 receives, as an input, an input text 901 (see FIG. 2) including one or more characters or data equivalent to the characters, and outputs the input text 901 to the blocking unit 102. At this time, the output to the blocking unit 102 may be a result of performing a process such as removal of unnecessary character codes or shaping of the text by the input unit 101. Further, in the input unit 101, processes such as morphological analysis and dependency analysis may be performed.

FIG. 2 is a diagram showing the input text 901 and a processing example of the blocking unit 102. The input text 901 shown in FIG. 2 is an utterance text of participants in a certain online conference. The input text 901 includes a total of eight utterances, and the eight utterances are arranged in time series from top to bottom. The input text 901 may be or may not be in time series. In the first embodiment, a description will be made assuming that the input text 901 is arranged in time series.

The blocking unit 102 divides or extracts (blocks) the text received from the input unit 101 into specific blocks, and outputs the specific blocks to the summarizing unit 103-1. Hereinafter, the blocked input text 901 output from the blocking unit 102 is referred to as a blocked text 102a. In the first embodiment, a description will be made on an assumption that blocking refers to segmenting the text received from the input unit 101 by a specific topic, but the blocking may be performed in any manner. In addition to segmenting by a topic, for example, various methods may be conceived such as extracting an important portion, blocking in units of the number of blocks having a fixed length, blocking by time, and the like.

For example, the blocking unit 102 estimates breakpoints of the topics of the text received from the input unit 101 using machine learning, and divides the text into blocks. FIG. 2 shows an example of a process in which the blocking unit 102 blocks the input text 901 to convert the input text 901 into the blocked text 102a. In the blocking example in FIG. 2, since three consecutive utterances of “Utterance: Ah, excuse me, I can't, ah, I can't hear voice”, “Utterance: Hello? Can you hear me?”, and “Utterance: Yes, I can. Yes, I can hear you” contained in the input text 901 can be regarded as one topic related to a connection state of the online conference, these three utterances are regarded as a group of “block 1”.

In addition, two consecutive utterances of “Utterance: There is an evacuation drill in, Uh, today's afternoon, so” and “Utterance: When you hear a broadcast, hide, hide under a desk, then, a roll call, a roll call will be performed, so, uh, please take this seriously” contained in the input text 901 are instructions related to the evacuation drill in the online conference, and these two utterances are regarded as a group of “block 2”. Further, three consecutive utterances of “Utterance: Sorry, I'm out today and can't attend”, “Utterance: I see”, and “Utterance: I'm clear, but Mike, please read the evacuation manual” contained in the input text 901 are information shared among the utterers related to the evacuation drill in the online conference, and these three utterances are regarded as a group of “block 3”.

A method for blocking by the blocking unit 102 may be any method. As the blocking method, for example, a manual selection method and an automatically blocking method using a rule base or machine learning, or the like may be considered. In addition, in the automatic blocking using the machine learning, a long short term memory (LSTM) and a language model may be used.

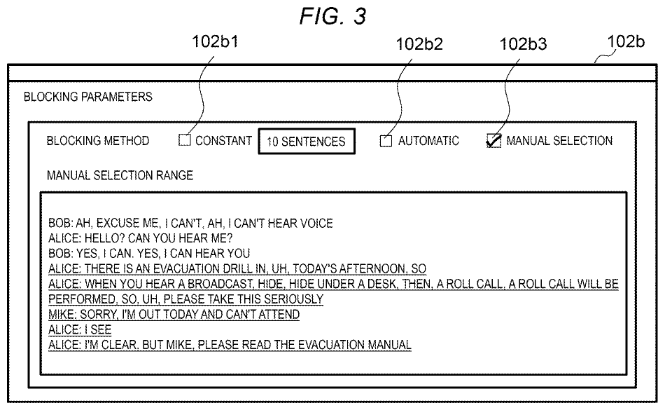

FIG. 3 is a diagram showing an input screen of blocking parameters for determining an operation of the blocking unit 102 according to the first embodiment. A blocking parameter input screen 102b in FIG. 3 is provided with checkboxes for adjusting parameters required for blocking. The blocking parameter input screen 102b is provided with a first checkbox 102b1, a second checkbox 102b2, and a third checkbox 102b3. The first checkbox 102b1 is used to select a function of blocking a text with the predetermined number of sentences. The second checkbox 102b2 is used to select a function of automatically blocking using the machine learning, or the like. The third checkbox 102b3 is used to select a function of manually selecting the blocking.

Further, when the blocking is input by the manual selection, a range can be specified. The blocking parameter input screen 102b shows that three consecutive utterances of “Bob: Ah, excuse me, I can't, ah, I can't hear voice”, “Alice: Hello? Can you hear me?”, and “Bob: Yes, I can. Yes, I can hear you” are unselected, and are removed from an input to the summarizing unit 103-1. For the convenience of drawing the figure, in FIG. 3, underlines given to utterances indicate that the utterances are selected.

The above checkboxes are an example, and the type of an item does not matter. In addition, the blocking parameter input screen 102b may have a hierarchical structure or may include a plurality of pages. In addition, the blocking parameter input screen 102b may be a graphical user interface (GUI) or a character user interface (CUI). In addition, the blocking parameters input in the blocking parameter input screen 102b may be stored in a DB or the text, or may be stored in a volatile memory.

It is expected that, for example, since the blocking unit 102 performs the blocking based on appropriate breakpoints of the topics from the input text 901, a single topic is contained in the text of each block output from the blocking unit 102. Therefore, by performing summarization and structuring for each block, a high-accuracy summary can be presented. Therefore, each of the summarizing unit 103-1 and the structuring unit 103-2 of the block-unit processing unit 103 processes the text in units of the blocked text output from the blocking unit 102. Accordingly, the summarization and structuring with respect to a single topic can be appropriately performed.

The summarizing unit 103-1 receives the blocked text 102a from the blocking unit 102 as an input, summarizes the text in block units to generate a summarized text 103a, and outputs the summarized text 103a to the structuring unit 103-2. As a summarization method used by the summarizing unit 103-1, various method such as extractive summarization and abstractive summarization can be used. When the summarizing unit 103-1 uses the extractive summarization as a summarizing method, for example, it is considered to extract important words, phrases, and/or sentences by method of a rule base, machine learning, or the like.

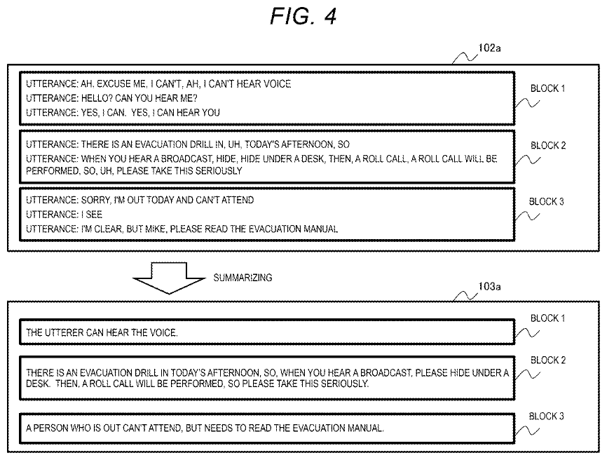

FIG. 4 is a diagram showing a processing example of the summarizing unit 103-1. However, here, the summarizing unit 103-1 uses the abstractive summarization as the summarizing method. In the example shown in FIG. 4, the blocked text 102a is input to the summarizing unit 103-1, and the summarizing unit 103-1 outputs the summarized text 103a. As shown in the summarized text 103a, a text in each block of the blocked text 102a is summarized by rewriting a corresponding original sentence, thereby generating a summary sentence that holds important information on the topic of each block, which is fluency and simple.

For example, the block 1 in the blocked text 102a, which includes “Utterance: Ah, excuse me, I can't, ah, I can't hear voice”, “Utterance: Hello? Can you hear me?”, and “Utterance: Yes, I can. Yes, I can hear you” is converted by the summarizing unit 103-1 to “the utterer can hear the voice.”.

In addition, the block 2 in the blocked text 102a, which includes “Utterance: There is an evacuation drill in, Uh, today's afternoon, so” and “Utterance: When you hear a broadcast, hide, hide under a desk, then, a roll call, a roll call will be performed, so, uh, please take this seriously” is converted by the summarizing unit 103-1 to “There is an evacuation drill in today's afternoon, so, when you hear a broadcast, please hide under a desk. Then, a roll call will be performed, so please take this seriously.”.

Further, the block 3 in the blocked text 102a, which includes “Utterance: Sorry, I'm out today and can't attend”, “Utterance: I see”, and “Utterance: I'm clear, but Mike, please read the evacuation manual” is converted by the summarizing unit 103-1 to “A person who is out can't attend, but needs to read the evacuation manual.”.

The structuring unit 103-2 receives, as an input, a summarization result with respect to each of the blocked texts, which is output by the summarizing unit 103-1, and outputs the summarization result as a summarization result 902. The structuring unit 103-2 converts, in accordance with a specific procedure, the summary sentence to a format that is easy for the user to read. The drawings which will be described later show an example of structuring in which a central sentence and a supplementary sentence of a topic are expressed in a bullet list format and by indentation.

A form of the structuring may be any form. In this case, a method of structuring based on a discussion structure or a method of displaying a specific semantic label with respect to each sentence contained in the blocks is considered. In addition, the structuring may not include paragraphs or a bullet list. In addition, in the first embodiment, the structuring is expressed as a text, but a drawing or a table may be included. Further, in the structuring unit 103-2, any method may be used as long as the method is a method of performing the structuring. In this case, in order to implement the structuring unit 103-2, for example, a method of a rule-based sentence classifier, a discussion structure analyzer using machine learning, or the like is considered.

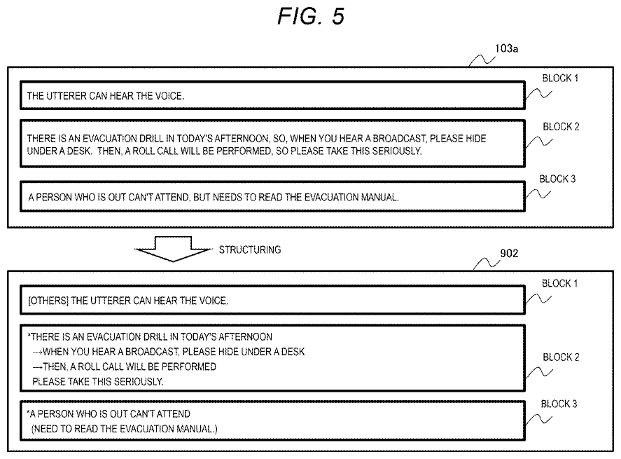

FIG. 5 is a diagram showing a processing example of the structuring unit 103-2. In the example shown in FIG. 5, the summarized text 103a is input to the structuring unit 103-2, and the structuring unit 103-2 outputs the summarization result 902. In FIG. 5, the blocked summarized text 103a is structured centering on the topic of the block in each block.

At this time, for example, “The utterer can hear the voice.” in the block 1 in the summarized text 103a is not a summary directly related to a discussion, and thus “The utterer can hear the voice” is structured as “[Others] The utterer can hear the voice.” by the structuring unit 103-2. At this time, “[Others]” is a semantic label assigned by the structuring unit 103-2. The type of the label is not limited to “[Others]”, and may be any type. In this case, for example, labels such as “assertion”, “reason”, and “question” are considered. In addition, two or more labels may be assigned to a single block, sentence, phrase, or word.

Next, for example, “There is an evacuation drill in today's afternoon, so, when you hear a broadcast, please hide under a desk. Then, a roll call will be performed, so, please take this seriously.” in block 2 in the summarized text 103a is displayed in a state in which the structuring unit 103-2 structures the topic and supplementary information using the indention and the bullet list format so that “*There is an evacuation drill in today's afternoon”, “→ When you hear a broadcast, please hide under a desk”, “→ Then, a roll call will be performed”, and “ please take this seriously.”.

In the display in the structured state, a sentence starting from “*” is a sentence representing a topic. A sentences starting from “→” are sentences representing the supplementary information and are bulleted lists. Symbols for structuring such as “*” and “→” are merely examples, and any symbol may be used. In addition, any form, such as a label, a character, a word, and a diagram, instead of a symbol, may be used as long as the form is a method that does not impair readability.

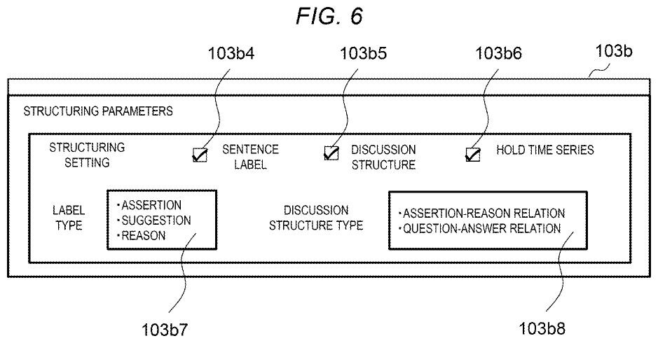

FIG. 6 is a diagram showing an input screen of structuring parameters for determining an operation of the structuring unit 103-2. A structuring parameter input screen 103b in FIG. 6 is provided with checkboxes for adjusting parameters required for structuring. For example, the structuring parameter input screen 103b is provided with a fourth checkbox 103b4, a fifth checkbox 103b5, and a sixth checkbox 103b6. The fourth checkbox 103b4 is used to select a function of displaying a specific label for each sentence. The fifth checkbox 103b5 is used to select a function of performing the bullets and the indentation by using discussion structure analysis. The sixth checkbox 103b6 is used to select a function of considering a time series in an order of appearance of the sentences displayed by structuring.

The structuring parameter input screen 103b is further provided with a first text box 103b7 in which the type of the specific label described above can be written, and a second text box 103b8 in which the type of a discussion structure to be analyzed can be specified. The checkboxes and the text boxes are an example, and the type of an item or a user interface is not limited. In addition, the structuring parameter input screen 103b may have a hierarchical structure or may include a plurality of pages. In addition, the structuring parameter input screen 103b may be implemented by a GUI or a CUI. In addition, the structuring parameters input in the structuring parameter input screen may be stored in the DB or the text, or may be stored in the volatile memory.

According to the first embodiment described above, the following effects are obtained.

(1) A text summarization method executed by a computer 600 implementing the text summarization system 100 includes a blocking step executed by the blocking unit 102, a summarizing step executed by the summarizing unit 103-1, and a structuring step executed by the structuring unit 103-2. In the blocking step, an input of the input text 901 is received, and the blocked text 102a in which the text is segmented into blocks in topic units is generated. In the summarizing step, content of the text is summarized for each block in the blocked text 102a, and the summarized text 103a is output. In the structuring step, the content of the summarized text 103a is structured and output. Therefore, the text can be automatically summarized with high accuracy. A background leading to a configuration of the present embodiment will be described in detail.

With a dramatic improvement in performance of abstractive summarization performed by a language model in recent years, automatic summarization with fluency and high accuracy can be performed comparable to human summarization. It is confirmed that, by using a language model provided with parameters acquired from a text in enormous volume by a framework of pre-learning performed based on a masked language model or a permutation language model, the performance is dramatically improved in viewpoints of fluency, consistency, and logic as compared with the abstractive summarization in the related art. Accuracy of the abstractive summarization with respect to the utterance text is also remarkably improved. For example, by using a language model BART acquired from a conversation text by pre-learning, the utterance text can be fluently summarized.

Therefore, it is considered that the linguistic and semantic unnaturalness of the summarization can be solved by a method of “summarizing and then structuring” performed by the abstractive summarization using the language model, instead of the method of “structuring and then summarizing” in the related art. By performing the method of “summarizing and then structuring”, not only the above problem can be solved, but also accuracy of structuring, which is a process in a subsequent stage, is improved since accuracy of the summarization performed before the structuring is high. Therefore, it is possible to present a high-accuracy summarization result that is structured to be easy for the user to read.

For “summarizing and then structuring” by the abstractive summarization using the language model, first, it is necessary to summarize the utterance text. However, since the utterance text is very long, a length of a string of tokens (token string) including words and characters contained in the utterance text often exceeds an input length that the language model can receive. Therefore, at this time, the utterance text cannot be directly input to the abstractive summarization using the language model.

Further, a conference may have a plurality of agenda items, and topics of the utterance text greatly differ depending on a time series. In such a situation, when the abstractive summarization is applied to the utterance text as it is, there is a problem that a summary in which the topics are scattered is generated, or a problem that an important topic is ignored. Presenting such a scattered result of the topics is a reason causing degradation in the performance of the automatic summarization. In this case, even though the utterance text is structured and displayed, if the performance of the automatic summarization is low, the accuracy of the structuring is also low. Therefore, before performing the method of “summarizing and then structuring”, appropriate blocking according to topics is performed on the utterance text, the summarization is performed in each block, and then the structuring is performed, whereby the text can be automatically summarized with high accuracy.

(2) In the structuring step, the structuring is performed in units of the text blocked in the blocking step. Therefore, since each of the blocks segmented in topic units is structured, it is easy to grasp the content.

### First Modification

In the first embodiment described above, the summarizing unit 103-1 processes the utterance text in block units. However, the structuring unit 103-2 may not necessarily process the utterance text in block units. For example, a plurality of blocks may be structured as one group.

### Second Embodiment

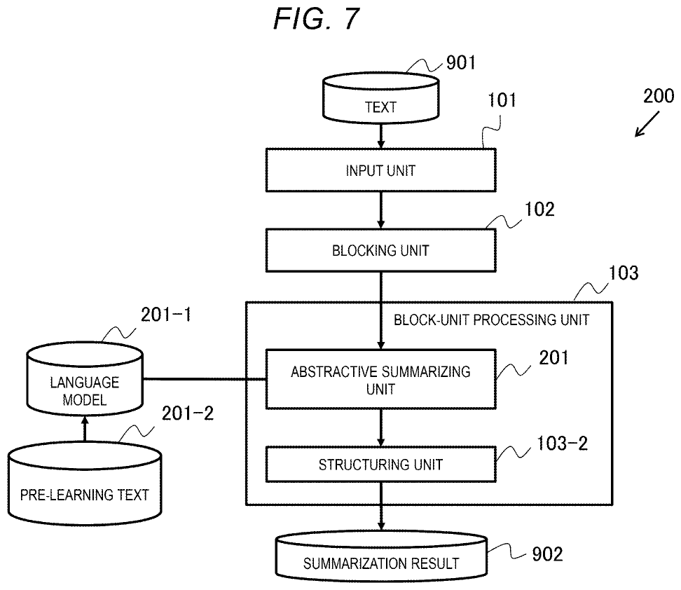

A text summarization system according to a second embodiment will be described with reference to FIG. 7. In the following description, the same components as those of the first embodiment are denoted by the same reference numerals, and differences will be mainly described. Points that are not specifically described are the same as those of the first embodiment. The present embodiment is different from the first embodiment mainly in that advanced abstractive summarization is performed.

### System Configuration

FIG. 7 is a system configuration diagram of a text summarization system 200 according to the second embodiment. The text summarization system 200 includes the input unit 101, the blocking unit 102, the block-unit processing unit 103, an abstractive summarizing unit 201, a language model 201-1, and a pre-learning text 201-2. In the present embodiment, it is possible to perform more fluency and high-accuracy summarization by changing the summarizing unit 103-1 described in the first embodiment to abstractive summarization using the language model 201-1. That is, although the summarizing unit 103-1 according to the first embodiment includes both the abstractive summarization and the extractive summarization, the present embodiment is limited to the abstractive summarization with higher accuracy than that of the abstractive summarization according to the first embodiment.

The abstractive summarizing unit 201 receives a blocked text from the blocking unit 102, and performs the abstractive summarization using the language model 201-1 on the text contained in each block. In order to perform the high-accuracy abstractive summarization, the language model 201-1 is trained using the pre-learning text 201-2, and the trained language model 201-1 is used as an abstractive summarization generator. The pre-learning text 201-2 is a pre-learning text of the language model 201-1. The pre-learning text 201-2 may be acquired based on a Web page or a text contained in a book, or may be data unique to a user, such as a conversation history.

As the language model 201-1, a method in which a transformer encoder such as BERT is used or a method in which a decoder and the transformer encoder such as BART are combined is considered, but a specific method is not limited. In this case, a method in which only the transformer decoder is used, a method in which an LSTM is used, or the like may be considered. Further, a method in which the abstractive summarization and the extractive summarization are combined may be used.

According to the second embodiment described above, the following effect is obtained.

(3) In the summarizing step, the abstractive summarization using the language model 201-1 is performed. Therefore, the summarization is automatically performed with fluency and high accuracy.

### Third Embodiment

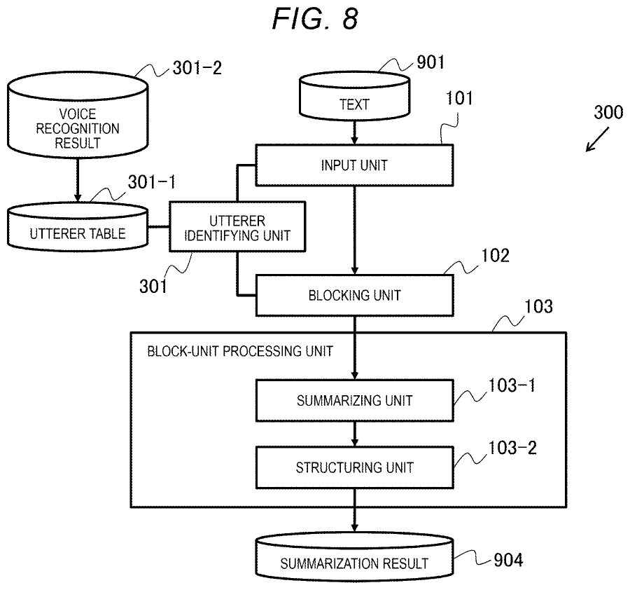

A text summarization system according to a third embodiment will be described with reference to FIGS. 8 to 10. In the following description, the same components as those of the first embodiment are denoted by the same reference numerals, and differences will be mainly described. Points that are not specifically described are the same as those of the first embodiment. The present embodiment is different from the first embodiment mainly in that the utterers are identified.

### System Configuration

FIG. 8 is a system configuration diagram of a text summarization system 300 according to the third embodiment. The text summarization system 300 includes the input unit 101, an utterer identifying unit 301, an utterer table 301-1, a voice recognition result 301-2, the blocking unit 102, the block-unit processing unit 103, the summarizing unit 103-1, and the structuring unit 103-2. In the present embodiment, utterer identification is performed on the input unit 101 or the blocking unit 102, and a vocalization content of an utterance text is associated with a person who is a subject of each utterance content. By performing the utterer identification, automatic summarization can be performed from an objective viewpoint.

The utterer identifying unit 301 receives a text output from the input unit 101 or a blocked text output from the blocking unit 102, and outputs the utterance content contained in the text in association with an utterer. In addition, an identified utterer is stored in the utterer table 301-1. The utterer identifying unit 301 operates using not only text information but also the voice recognition result 301-2.

The voice recognition result 301-2 stores not only the utterance text but also information for identifying the utterance text and utterers of the utterance text. Various formats are conceived for the information for identifying the utterer, for example, a voice waveform and a text containing a name of the utterer. In addition, the utterer table 301-1 may be a structured format such as a DB or a non-structured format such as a text. Further, a method for identifying the utterers may be any method as long as the method associates the utterance text with the utterers. At this time, for example, it is conceived to identify the utterers using a neural network or to use commercially available or free voice recognition software.

A text to which the information on the utterers is added by the utterer identifying unit 301 is input to the summarizing unit 103-1 for each block in the same manner as that of the first embodiment. Further, an output of the summarizing unit 103-1 is structured by the structuring unit 103-2, and is output as a summarization result 904. The output summarization result 904 is different from those of the first embodiment and the second embodiment, objective summarization is performed by writing the information on the utterers in a summary.

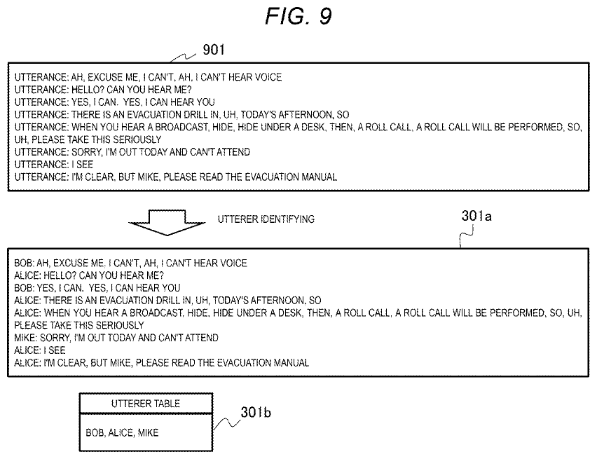

FIG. 9 is a diagram showing an example of identifying the utterers. In FIG. 9, the utterer identifying unit 301 identifies the utterer based on each utterance content in the input text 901 received from the input unit 101. Further, information on the identified utterer is added to the input text 901, and an intermediate text 301a to be input to the blocking unit 102 is obtained. In addition, the information on the identified utterer is stored in an utterer table 301b. In FIG. 9, three utterers of “Bob”, “Alice”, and “Mike” are identified.

For example, an utterer of the two utterances of “Utterance: Ah, excuse me, I can't, ah, I can't hear voice” and “Utterance: Yes, I can. Yes, I can hear you” in the input text 901 is identified as Bob. In addition, an utterer of the five consecutive utterances of “Utterance: Hello? Can you hear me?”, “Utterance: There is an evacuation drill in, Uh, today's afternoon, so”, “Utterance: When you hear a broadcast, hide, hide under a desk, then, a roll call, a roll call will be performed, so, uh, please take this seriously”, “Utterance: I see”, and “Utterance: I'm clear, but Mike, please read the evacuation manual” in the input text 901 is identified as Alice. An utterer of “Utterance: Sorry, I'm out today and can't attend” in the input text 901 is identified as Mike.

Further, as shown in the intermediate text 301a, the text is corrected in a format in which a name of the utterer is displayed at a head of each utterance in the input text 901. In addition to the intermediate text 301a, various method are considered to add the information on the utterers. For example, a file including at least one of the utterer table, the DB, and metadata may be used.

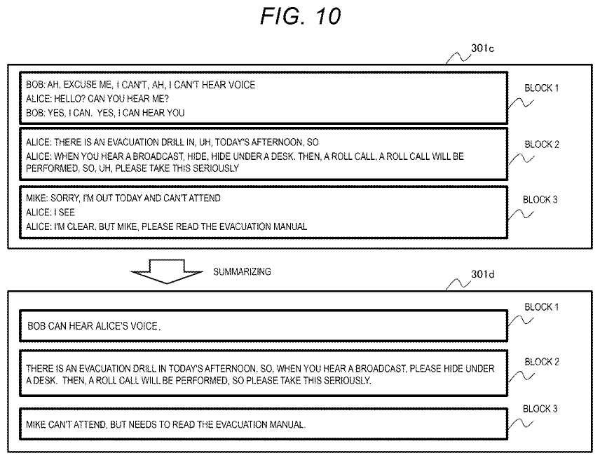

FIG. 10 is a diagram showing an example of performing the blocking and the structuring after the utterers are identified. In the intermediate text 301a in FIG. 9, when the text in which the utterers are identified is blocked, the text is divided into three blocks as in a text 301c in FIG. 10. The blocking is performed by the blocking unit 102 described in the first embodiment. A summarized text 301d in FIG. 10 is a result obtained by summarizing the text 301c using the summarizing unit 103-1. Since the summarized text 301d is different from the summarized text 103a in FIG. 4 and contains the information on the utterers such as Alice, Bob, and Mike, the summarized text 301d can be said to be an objective summary.

According to the third embodiment described above, the following effect is obtained.

(4) The text 901 is utterances of one or more persons. The text summarization method executed by the computer 600 implementing the text summarization system 300 includes an utterer identifying step executed by the utterer identifying unit 301. In the utterer identifying step, the utterers are estimated using the input text 901 or the blocked text 102a as a processing target. In the summarizing step executed by the summarizing unit 103-1, the objective summary is generated using the information on the utterers estimated in the utterer identifying step. Specifically, the summarizing unit 103-1 can generate a summary containing the information on the utterers as shown in a lower part of FIG. 10.

### Fourth Embodiment

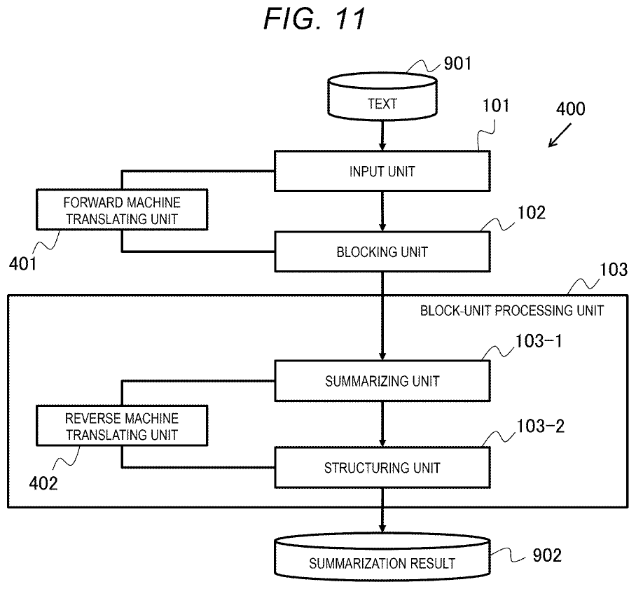

A text summarization system according to a fourth embodiment will be described with reference to FIG. 11. In the following description, the same components as those of the first embodiment are denoted by the same reference numerals, and differences will be mainly described. Points that are not specifically described are the same as those of the first embodiment. The present embodiment is different from the first embodiment mainly in that the text is translated.

FIG. 11 is a system configuration diagram of a text summarization system 400 according to the fourth embodiment. The text summarization system 400 includes the input unit 101, the blocking unit 102, a forward machine translating unit 401, the block-unit processing unit 103, the summarizing unit 103-1, the structuring unit 103-2, and a reverse machine translating unit 402.

A case in which a language of a text input to the text summarization system 400 is different from a native language of a user who uses an output of the text summarization system 400 is assumed. In this case, for example, a case in which an input text is in Japanese, and a summarization result to be output is in English and presented to the user is considered. In addition, software or a program used for sentence classification, discussion structure analysis, or blocking, summarizing, or structuring performed based on a rule base may have a restriction on languages, for example, a restriction that can handle only Japanese. Therefore, for example, when the input text is in English and the software used in the blocking unit 102, the summarizing unit 103-1, and the structuring unit 103-2 supports only Japanese, the automatic summarization cannot be realized. In the present embodiment, the input and output of the text summarization system described in the first embodiment can be supported in multiple languages. It is possible to perform high-accuracy summarization in various languages.

The forward machine translating unit 401 receives a text output from the input unit 101 or a blocked text output from the blocking unit 102, and translates the text into a specific language. For example, the forward machine translating unit 401 receives an input English text and translates the input English text into a Japanese text. Languages handled by the forward machine translating unit 401 is not limited to a pair of English and Japanese (English-Japanese pair), and may be any language pair. Further, a method used for the machine translation may be any method. For example, for the machine translation, a neural translation model, open-source software, a web service for machine translation, and the like can be used.

The reverse machine translating unit 402 receives a text output from the summarizing unit 103-1 or the structuring unit 103-2, and translates the text into a specific language. For example, the reverse machine translating unit 402 receives a Japanese text and translates the Japanese text into an input

English text. Languages handled by the reverse machine translating unit 402 is not limited to a pair of Japanese and English (Japanese-English pair), and may be any language pair. Further, similar to the forward machine translating unit 401, a method used for the machine translation may be any method.

In the present embodiment, the language pair to be processed by the forward machine translating unit 401 and the language pair to be processed by the reverse machine translating unit 402 will be described on a premise of symmetry. For example, when the forward machine translating unit 401 performs English-to-Japanese translation and the reverse machine translating unit 402 performs Japanese-to-English translation, English and Japanese satisfy the symmetry between input and output. At this time, the input text and a summarization result presented to the user are in English, and the blocking unit 102, the summarizing unit 103-1, and/or the structuring unit 103-2 that perform actual automatic summarization are implemented in Japanese. Therefore, even if a language to be processed by software available in the blocking unit 102 and the summarizing unit 103-1 is limited to Japanese, the automatic summarization of the English text can be realized.

Meanwhile, the forward machine translating unit 401 and the reverse machine translating unit 402 can freely switch ON/OFF of functions. For example, by turning off the function of the forward machine translating unit 401, receiving the input Japanese text, and performing the Japanese-to-English translation by the reverse machine translating unit 402, a result of summarizing the Japanese text in English can be presented to the user.

According to the fourth embodiment described above, the following effects are obtained.

(5) A text summarization method executed by the text summarization system 400 further includes one of a forward translating step of translating the text or the blocked text and inputting a text translated into a language different from that of the text in the summarizing step, and a reverse translating step of translating an output in the summarizing step or the structuring step. Therefore, the summarization result 902 can be output in a language different from that of the input text 901. In addition, a translation timing can be freely selected from before processing of the blocking unit 102, before processing of the summarizing unit 103-1, and before processing of the structuring unit 103-2 in accordance with a language that can be supported by each processing unit.

(6) The text summarization method executed by the text summarization system 400 further includes the forward translating step of translating the text or the blocked text and inputting a text translated into a language different from that of the text in the summarizing step, and the reverse translating step of translating an output in the summarizing step or the structuring step. Therefore, even if the input text 901 is the same as the summarization result 902, it is possible to absorb a difference between the language that can be supported by the blocking unit 102, the summarizing unit 103-1, and the structuring unit 103-2 and the language of the input text 901 and the summarization result 902.

### Hardware Configuration

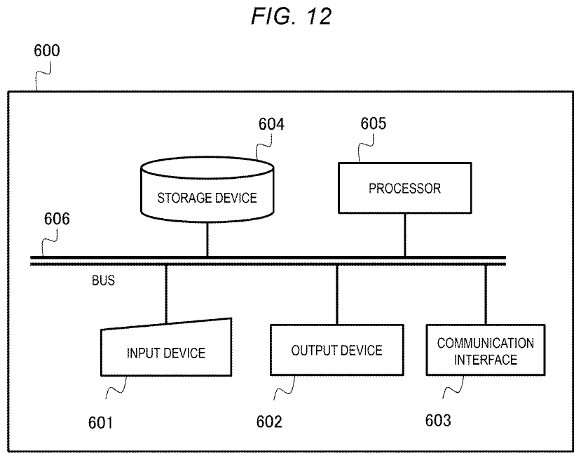

FIG. 12 is a hardware configuration diagram of the computer 600 that implements the text summarization systems 100, 200, 300, and 400 in the first to fourth embodiments described above. The computer 600 includes an input device 601, an output device 602, a communication interface 603, a storage device 604, a processor 605, and a bus 606. The input device 601, the output device 602, the communication interface 603, the storage device 604, the processor 605, and the bus 606 are connected to each other via the bus 606 and communicate with each other.

The input device 601 is a device through which the user inputs a text or an instruction to be processed to the text summarization systems 100, 200, 300, and 400. The input from the input device 601 may be stored in the storage device 604. The input device 601 includes, for example, a keyboard, a touch panel, a mouse, a microphone, a camera, and a scanner.

The output device 602 presents, to the user, the summarization results output by the text summarization systems 100, 200, 300, and 400. The output device 602 includes, for example, a display, a printer, or a speaker. When the output device is a display or a printer, for example, the summarization result 902 output by the text summarization system 100 can be displayed. In addition, the output device 602 can also read aloud the summarization result 902 through a speaker. When the output device 602 is the display, for example, the blocking parameter input screen 102b shown in FIG. 3 or the structuring parameter input screen 103b shown in FIG. 6 can be displayed.

The communication interface 603 is connected to a network, and transmits and receives various data required for an operation of the computer 600. When information is input or output to the text summarization system 200 via the communication interface 603, the computer 600 may not include the input device 601 and the output device 602. In addition, the text summarization systems 100, 200, 300, and 400 can transmit and receive the data from any terminal via the network.

The processor 605 causes the computer 600 to calculate in accordance with any instruction set and to execute a program. In addition, the processor 605 can include a single or a plurality of calculation devices and a plurality of processing devices. The processor 605 may be any device as long as the processor 605 is a calculation device that operates in accordance with any instruction set. At this time, for example, a device using a central processing unit (CPU) or graphics processing units (GPU) is considered. In addition, the processor 605 may be implemented as any device that performs a signal operation according to, for example, a microprocessor, a digital signal processor, a microcomputer, a microcontroller, a state machine, a logic circuit, a chip-on system, or a control instruction.

The storage device 604 serves as a work area of the processor 605. The storage device 604 records data and a program for executing the text summarization systems 100, 200, 300, and 400. Specifically, the storage device 604 is a storage medium including a non-volatile device or a volatile device. The storage device 604 may be any medium as long as the storage device 604 is a storage medium. Further, the storage device 604 is connected by the bus of the computer 600, but may be connected through the communication interface. As the storage device 604, for example, a read only memory (ROM), a random access memory (RAM), a hard disk drive (HDD), or a solid state drive (SSD) can be used.

Specifically, for example, each processing unit of the text summarization systems 100, 200, 300, and 400 shown in FIG. 1 and the like is implemented by the processor 605 interpreting a temporary or non-transitory program stored in the storage device 604 and executing calculation of an instruction set obtained by the interpretation. In addition, each data of the input text 901, the language model 201-1, the pre-learning text 201-2, the utterer table 301-1, the voice recognition result 301-2, the summarization result 902, and the summarization result 904, which is used in each processing unit of the text summarization systems 100, 200, 300, and 400 shown in FIG. 1 and the like, is stored in, for example, the storage device 604.

In the text summarization systems 100, 200, 300, and 400, for example, the program or the instruction set executed by the processor 605 can include an operating system (OS) or any application software. In addition, the text summarization systems 100, 200, 300, and 400 can include programs such as an input program, a blocking program, a summarization program, a structuring program, an abstractive summarization program, an utter identification program, a forward machine translating program, and a reverse machine translating program.

For example, in the text summarization systems 100, 200, 300, and 400 according to the embodiments shown in FIG. 1 and the like, the processor 605 can execute these programs, operate, and function as the input unit 101, the blocking unit 102, the summarizing unit 103-1, and the structuring unit 103-2. In addition, for example, in the text summarization systems 200, 300, and 400 according to the embodiments shown in FIGS. 7, 8, and 11, the processor 605 can execute the programs described above, operate, and function as the abstractive summarizing unit 201, the utterer identifying unit 301, the forward machine translating unit 401, and the reverse machine translating unit 402.

In FIG. 12, all kinds of software including the OS and the programs of the text summarization systems are stored in a storage area of the storage device 604. Each program may be recorded in a portable recording medium in advance. In this case, a target program is read from the portable recording medium by a medium reading device or the communication interface. In addition, the OS or the software, and the programs may be acquired via a communication medium.

In an embodiment of the computer 600, various forms are conceived. For example, each the text summarization system includes a single or a plurality of processors, and can be implemented by one or more computers including a single or a plurality of storage devices. That is, in FIG. 12, the text summarization system 100 may be implemented by a plurality of computers 600. When the text summarization system is implemented in a system implemented by a plurality of computers, each piece of data required for the operation of the text summarization system is communicated via a computer network in which the computers are mutually or partially connected. In this case, some or all of the plurality of processing units provided in the text summarization system may be implemented in a single computer, and some or all of the other processing units may be implemented in a computer other than the computer described above.

Functional block configurations in the embodiments and modification described above are merely examples. Some functional configurations shown as separate functional blocks may be integrated, or a configuration represented by one functional block diagram may be divided into two or more functions. A part of functions of each functional block may be provided in another functional block.

The embodiments and the modifications described above may be combined with each other. Although various embodiments and modifications are described above, the invention is not limited to the embodiments and the modifications. Other embodiments that are regarded within the scope of the technical idea of the invention also fall within the scope of the invention.

What is claimed is:

1. A text summarization method executed by a computer comprising:
a blocking step of receiving an input of a text and generating a blocked text in which the text is segmented into blocks in topic units;
a summarizing step of summarizing content of the text for each of the blocks in the blocked text and outputting a summarized text; and
a structuring step of structuring content of the summarized text and outputting the structured content.

2. The text summarization method according to claim 1, wherein
in the summarizing step, abstractive summarization using a language model is performed.

3. The text summarization method according to claim 1, wherein
the text is an utterance of one or more persons,
the text summarization method further comprises an utterer identifying step of estimating an utterer using the text or the blocked text as a processing target, and
in the summarizing step, an objective summary is generated using information on the utterer estimated in the utterer identifying step.

4. The text summarization method according to claim 1, further comprising:
one of a forward translating step of translating the text or the blocked text and inputting a text translated into a language different from that of the text in the summarizing step, and a reverse translating step of translating an output in the summarizing step or the structuring step.

5. The text summarization method according to claim 1, further comprising:
a forward translating step of translating the text or the blocked text and inputting a text translated into a language different from that of the text in the summarizing step; and
a reverse translating step of translating an output in the summarizing step or the structuring step.

6. The text summarization method according to claim 1, wherein
in the structuring step, structuring is performed in units of the text blocked in the blocking step.

7. A text summarization system comprising:
a blocking unit configured to receive an input of a text and generate a blocked text in which the text is segmented into blocks in topic units;
a summarizing unit configured to summarize content of the text for each of the blocks in the blocked text and output a summarized text; and
a structuring unit configured to structure content of the summarized text and output the structured content.
